(19) United States
(12) Patent Application Publication
(10) Pub. No.: US 2014/0159847 A1
(43) Pub. Date: Jun. 12, 2014

(54) ON-LOAD TAP CHANGER

(71) Applicant: Silke Wrede, Zeitlarn (DE)

(72) Inventor: Silke Wrede, Zeitlarn (DE)

(21) Appl. No.: 14/234,704

(22) PCT Filed: Aug. 9, 2012
(86) PCT No.: PCT/EP2012/065596

§ 371 Date: Jan. 24, 2014

(30) Foreign Application Priority Data
Sep. 17, 2011 (DE) 102011113718.5

(51) Int. Cl. H02P 13/06

(52) U.S. Cl. CPC H02P 13/06
USPC 336/150

(57) ABSTRACT

The invention relates to an on-load tap changer consisting of an energy store, a drive shaft designed as a screw spindle, vacuum switching tubes and a contact carrier and vertically arranged tap contacts. Actuation of the vacuum switching tubes occurs in dependence on the contacts. According to the invention, the vacuum switching tubes are actuated via cam discs and deflection assemblies. In parallel, the contacts attached to the contact carrier are moved vertically by the drive shaft and the tap contacts are thus actuated.

The invention relates to an on-load tap changer.

On-load tap changers and load selectors serve the purpose in transformers of switching over the winding taps of these transformers under load and thus selectively compensating for voltage changes at consumers.

On-load tap changers such as known from the published specification DE 10055406 C1 usually consist of a selector for power-free preselection of those winding taps of the transformer that are to be switched over to as well as of a load changeover switch for the actual uninterrupted changeover from the previously connected winding tap to the new, preselected winding tap. Present in the selector are at least two contact tracks connected with corresponding winding taps. One contact track conducts the current by way of a closed contact, whilst by way of the second contact track the next winding tap is preselected in order to conduct the current after the load changeover. The actual load changeover takes place with the help of vacuum switching tubes or mechanical contacts. Due to the oil contamination that occurs during switching the vacuum switching tubes or the mechanical contacts together with the associated mechanical components are accommodated in a separate oil vessel cylinder. Depending on type, the selector is located either in the transformer housing or in an individual oil vessel cylinder.

A disadvantage of the on-load tap changer resides in the fact that this consists of a very large number of components. This has the consequence that assembly and maintenance are very time-intensive and thus expensive.

Load selectors such as known from the published specification DE 3833126 A1 consist of, inter alia, an oil vessel cylinder. This consists of an insulating material and has a radially arranged, three-part cam track in the interior. Mounted below the cam track are three mains terminals that are arranged from the outside and that are connected with a wiper ring disposed in the interior. Disposed above the cam track are the tap contacts that are connected with the respective taps of the tap windings and extend in the interior of the cylinder. A switch shaft consisting of insulating material extends through the interior of the oil vessel cylinder. Two horizontally arranged vacuum switching tubes in a switch contact support, wiper contacts with guide arms and numerous other parts are fastened by way of a base plate and a part cylinder to this shaft. Through rotation of the switch shaft the cam track is scanned by the individual rollers of the switch contact support. The individual vacuum switching tubes are thereby actuated, which leads to a predefined switching sequence.

A disadvantage of such a load selector resides in the fact that the size and position of the vacuum switching tubes impose minimum demands on the constructional space and thus on the circumference of the oil vessel cylinder. Due to the radial arrangement of the connections for the individual winding taps at the circumference of the oil vessel cylinder and the predetermined minimum spacings of adjacent connections the divisibility, i.e. the maximum number of connections for a specific circumference, is limited. In addition, due to economy and the space requirement in a transformer the load selector cannot be constructed to be as large as desired.

A further disadvantage is the weight of the switch shaft, which is determined by the number of components and which has to be moved during switching. Since the switching processes elapse in fractions of seconds enormous forces have to be applied in order to bring the switching shaft together with the entire contact arrangement into motion. After termination of the switching process, however, these masses also have to be braked again. This leads to a high loading of the individual components, a high level of wear and frequent service intervals.

In addition, in the case of expansions of the load selector by further connections for additional winding taps of regulating windings the entire switching arrangement has to be newly conceived and designed. The function could otherwise not be guaranteed and the required switching times not maintained.

It is the object of the invention to create an on-load tap changer that combines the advantages of an on-load tap changer and a load selector, in that case has a small constructional space and can be increased in size in the simplest manner by additional switching contacts.

This object is fulfilled by an on-load tap changer with the features of the first claim. The subclaims relate to advantageous developments of the invention.

The invention is based on the general idea of fixing the switch contacts (vacuum switching tubes) that are actuatable by cam discs, to be stationary in position and to arrange not only the tap contacts for switching over from one winding to the next, but also the contacts and diverter contacts, which are actuated by a screw spindle, vertically one under the other below the switch contacts.

The invention shall be explained in more detail by way of example in the following on the basis of drawings, in which:

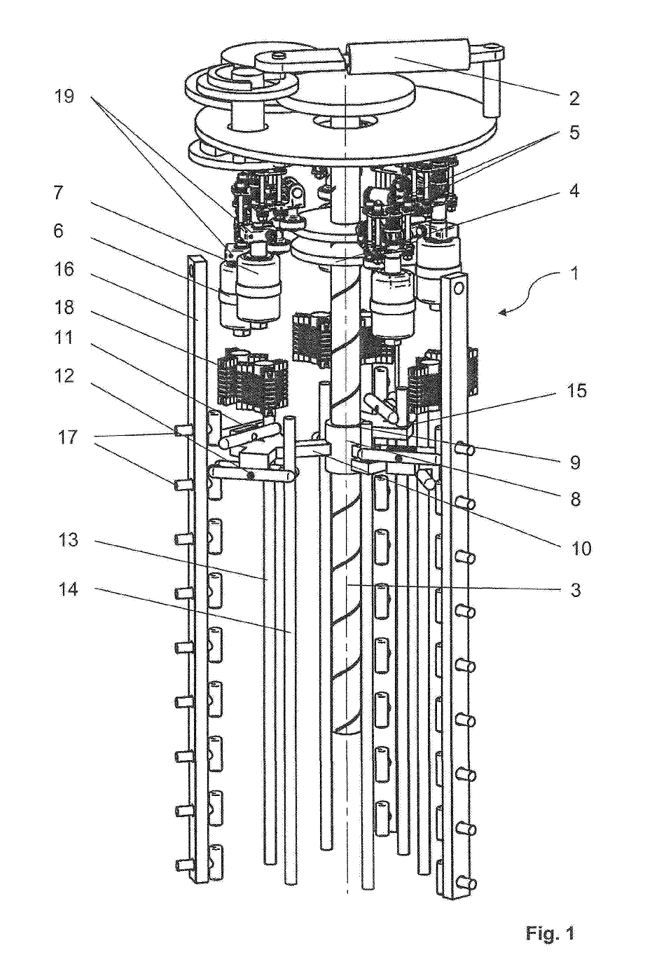

FIG. 1 shows an on-load tap changer according to the invention,

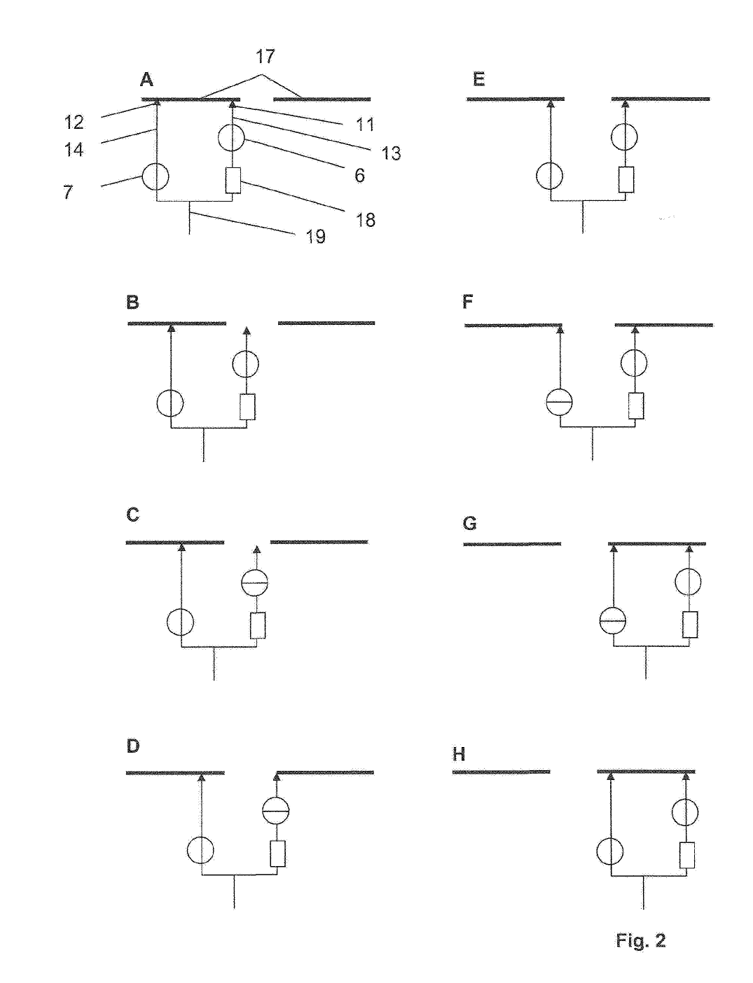

FIG. 2 shows a possible switching sequence of an on-load tap changer according to the invention from a first tap contact to a second tap contact,

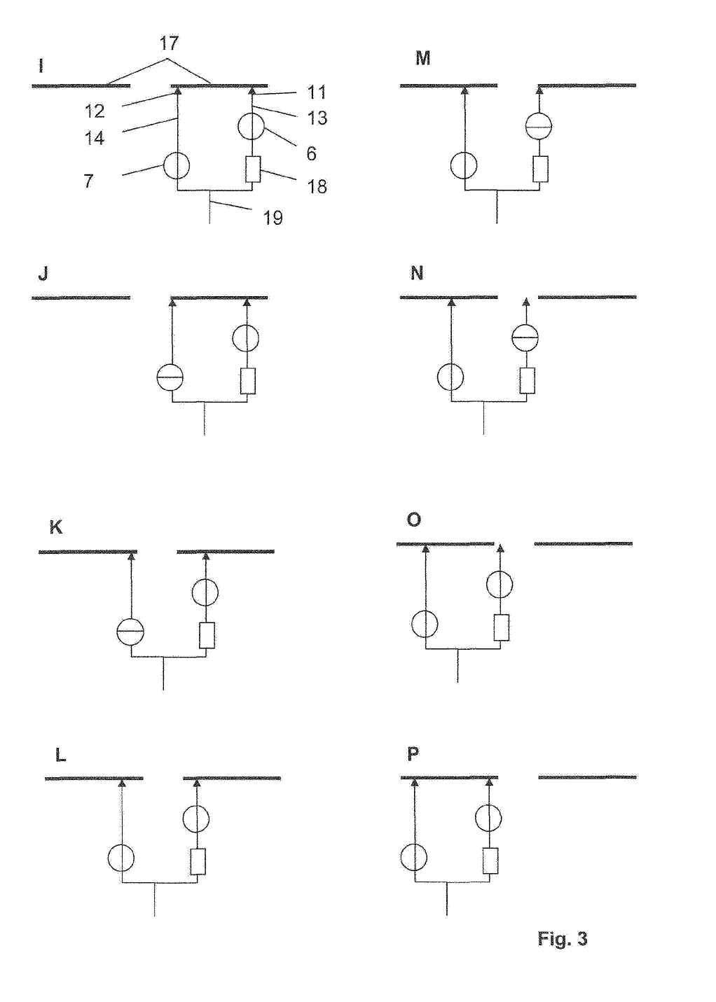

FIG. 3 shows a possible switching sequence of an on-load tap changer according to the invention from a second tap contact to a first tap contact and

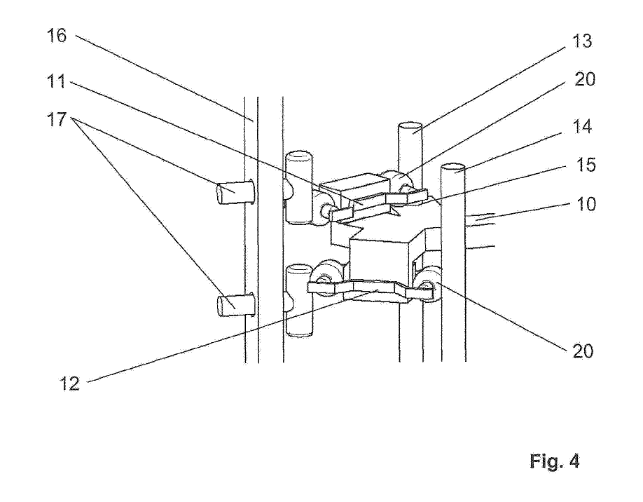

FIG. 4 shows a further form of embodiment of the contacts.

A three-phase on-load tap changer 1 according to the invention for tapped transformers is illustrated in FIG. 1. An energy store 2 is arranged at the upper end of the on-load tap changer 1. This energy store operates a drive shaft 3 that is constructed as a screw spindle and at which in the upper region at least two cam discs 4 are fixedly arranged. In the description there is always discussion of only one phase, but the embodiment according to the invention applies to each of the three phases. Five vacuum cells 6 and 7 can be opened and closed with the help of deflecting arrangements by rotation of the drive shaft 3 and the cam discs 4 fastened thereto.

In addition, a contact support 8 is mechanically connected with the drive shaft 3. Depending on the direction of rotation the contact support 8 can move vertically linearly upwardly or downwardly without in that case itself rotating. The contact support 8 consists of a sleeve element 9 and at least one contact arm 10. The sleeve element 9 is constructed in the interior in spindle-nut form and co-operates with the drive shaft 3 constructed as a screw spindle. The sleeve element 9 serves as connecting means between the drive shaft 3, which is constructed as a screw spindle, and the contact support 8. At least two contacts 11 and 12 electrically insulated from one another are arranged at an end of the contact arm 10. In the illustrated example the contacts 11 and 12 are constructed as sliding contact finger pairs.

At least two corresponding diverter contacts 13 and 14 are vertically associated with each contact arm 10 parallel to the drive shaft 3. The diverter contact 13 constantly has an electrically conductive and mechanically sliding connection with an end of the contact 11. Since in the example it is a contact finger pair, the diverter contact 13 slides therebetween. This applies equally to the diverter contact 14 and the contact 12.

In addition, the contact arm 10 is mechanically connected by way of a recess 15, in the form of a bore, with one of the diverter contacts, here the diverter contact 13. The diverter contact 13 thereby also has the function of a guide for the contact support 18 and prevents this from co-rotating with the drive shaft.

An insulating rod 16 of an electrically non-conductive material is associated with each contact arm 10 similarly parallel to the drive shaft 3. Electrically conductive tap contacts 17 are arranged in the insulating rod 16 linearly along a vertically extending path to co-operate with the contacts 11 and 12. These contacts 17 are mounted to be offset relative to one another and extend from the inner side of the insulating rod 16 to the outer sides. The different winding taps of the regulating transformer are connected with the tap contacts 17 on the outer side of the insulating rod 16. A frame for the on-load tap changer 1 can be formed in conjunction with other insulating rods 16. However, also conceivable is a simple cylinder of an electrically non-conductive material instead of the insulating rods 16 for fastening of the tap contacts 17.

Since the contacts 11 and 12 are constructed as sliding contact finger pairs the tap contacts 17 also slide between these. Thus, the tap contacts 17 are disposed at one end of the contacts 11 and 12 and the diverter contacts 13 and 14 at the other end. By virtue of this arrangement a conductive connection between the tap contacts 17 and the diverter contacts 13 and 14 can be produced.

In order to make possible flow of the load current the vacuum switching tube 7 and the diverter contact 14 are electrically connected together. The vacuum switching tube 6 is electrically conductively connected with the mains terminal by an additional resistance 18. The connection can be realized by, for example, copper strands or wires. The resistance 18 illustrated in FIG. 1 is a so-called resistance packet.

The switching sequence of the on-load tap changer 1 according to the invention is illustrated in FIG. 2 by the individual switching diagrams A-H. The initial state is depicted in switching diagram A. Here the two contacts 11 and 12 lie at the same tap contact 17. The two vacuum switching tubes 6 and 7 are closed. By virtue of the resistance 18 connected in series the current flows via the diverter contact 14 through the vacuum switching tube 7 to the diverter line 19.

Through triggering of the energy store 2 the stored energy is released through rotation of the drive shaft 3. The contact support is moved linearly downwardly or upwardly to the next tap contact 17 by the sleeve element 9. Initially the contact 11 detaches from the tap contact 17 (switching diagram B). In the next step the vacuum switching tube 6 is opened by way of a deflecting arrangement 5 with the help of a cam disc 4 that is similarly driven by the drive shaft 3 (switching diagram C). Until then the contact support 8 has covered such a path that the contact 11 bears against a next tap contact 17 (switching diagram D). Up to this point the current has flowed via contact 12 and vacuum switching tube 7 to the diverter line 18. The vacuum switching tube 6 is now closed by one of the cam discs 4. In that case, the so-called circular current (switching diagram E) arises. Another cam disc 4 thereupon opens the switching tube 7 (switching diagram F) so that the windings of the adjacent tap contact 17 can be tapped. In the next step the contact support 8 has moved to such an extent that also the contact 12 bears against the tap contact 17. In the last step (switching diagram H) the contacts 11 and 12 have reached the end setting thereof and one of the cam discs 4 closes the vacuum switching tube 7 so that the current can flow via this to the diverter line 19.

In FIG. 3 the switching sequence illustrated in FIG. 2 is illustrated in reverse sequence by the switching diagrams I-P. The initial setting (switching diagram I) here corresponds with the end setting (switching diagram H) in FIG. 2. The two vacuum switching tubes 6 and 7 are closed. The current flows from the tap contact 17 via the contact 14 and the vacuum switching tube 7 to the diverter line 19. After triggering of the energy store 2 the drive shaft 3 is rotated in the opposite direction, as described in FIG. 2. The contact support 8 moves in the direction of a next tap contact 17. Before the contact 14 detaches from the tap contact 17 a cam disc 14 opens the vacuum switching tube 7 (switching diagram J). The current now flows via the contact 11, the diverter contact 13, the vacuum switching tube 6 and the resistance 18. After the contact 14 has arrived at the adjacent tap contact 17 (switching diagram K) the vacuum switching tube 7 is closed by a cam disc 4 (switching diagram L). In this position the so-called circular current arises. Through further rotation of the drive shaft 3 one of the cam discs 4 actuates the vacuum switching tube 6 and opens this. The windings of the adjacent tap contact 17 are now tapped (switching diagram M). After the contact 11 has detached from the tap contact 17 (switching diagram N) the vacuum switching tube 6 is closed (switching diagram O). In the end setting the contacts 11 and 12 are disposed at the tap contact 17. The current again flows via the contact 12, the diverter contact 14 and the vacuum switching tube 7 to the diverter line 19.

By comparison with conventional load selectors only the camshafts 4 and the contact support 8 together with the contacts 11 and 12 associated therewith are moved by the drive shaft 3. These few components are lighter overall so that less energy is needed in order to move them. The vacuum switching tubes 6 and 7 as well as the resistance 18 are arranged in fixed position. The loads, which arise during braking of the parts, after a changeover substantially decrease. In addition, due to the fixed arrangement so-called bouncing during opening or closing of the vacuum switching tubes 6 and 7 is reduced.

Through the separation of the vacuum switching tubes 6 and 7 from the contacts 11 and 12 the on-load tap changer 1 is more compact and needs less constructional space. This is additionally promoted by the vertically oriented vacuum switching tubes 6 and 7 that reduce the diameter of the overall arrangement. In general, the compact mode of construction has fewer components by comparison with on-load tap changers of the prior art. As a consequence, construction, assembly and maintenance are less time-intensive and thus more economic. Due to the vertical arrangement of the tap contacts 17 the on-load tap changer 1 can, if required, be capable of extension in downward direction very simply and can be very easily enlarged by additional contacts for further regulating windings. The enlargement by further regulating windings can be realized significantly more simply than in the case of conventional on-load tap changers or load selectors.

An alternative form of the contacts 11 and 12 is depicted in FIG. 4. These are not constructed as sliding contacts, but have sliding rollers 20 at the ends. In the case of upward and downward movement, wear of the contacts 11 and 12 can be reduced by the rolling action.

### REFERENCE NUMERAL LIST

1 on-load tap changer
2 energy store
3 drive shaft
4 cam discs
5 deflecting arrangement
6 vacuum switching tube
7 vacuum switching tube
8 contact support
9 sleeve element
10 contact arm
11 contact
12 contact
13 diverter contact
14 diverter contact
15 bore
16 insulating rod
17 tap contact
18 resistance
19 diverter line
20 roller

1. An on-load tap changer for tapped transformers for uninterrupted changeover from one tap contact to an adjacent further tap contact, with an energy store, wherein a vertically arranged rotatable drive shaft is provided, wherein the drive shaft is mechanically connected with the contact support, wherein the contact support has one or more contacts for selectable electrical connection of fixed tap contacts, and diverter contacts that are electrically conductively connected with a diverter line by way of vacuum switching tubes, are provided, wherein
the fixed tap contacts are arranged linearly along a vertically extending track,
the drive shaft is so connected by way of a screw spindle with the contact support that the contact support executes a vertical movement when the drive shaft is rotated,
the vacuum switching tubes are firmly fixed in a region and
the vacuum switching tubes are actuated by cam discs that are connected with the drive shaft via deflecting arrangements.

2. The on-load tap changer according to claim 1, wherein the contact support comprises a contact arm with a recess and is thereby movably connected with at least one diverter contact and at least one of the diverter contacts serves as a guide.

3. The on-load tap changer according to claim 1, further comprising:
insulating rods carrying the fixed tap contacts and connectable to form a frame.

4. The on-load tap changer according to claim 1, further comprising:
an insulating cylinder or segments of an insulating cylinder carrying the tap contacts.

5. An on-load tap changer for tapped transformers, the tap changer comprising:
a housing;
a vertical straight row of tap contacts fixed on the housing;
a vertical drive spindle with a screwthread and extending in the housing parallel to the row of fixed tap contacts;
a contact carrier threaded on the drive spindle such that rotation of the spindle vertically shifts the carrier parallel o the row of fixed contacts;
a movable contact on the carrier vertically engageable with the fixed tap contacts;
a vacuum tube fixed on the housing;
a cam disk operatively connected to the vacuum tube for switching same; and
a diverter conductor connected between the movable contact and the vacuum tube.
